(19) United States
(12) Patent Application Publication
(10) Pub. No.: US 2003/0158752 A1
(43) Pub. Date: Aug. 21, 2003

(54) System and method for designing and running of clinical trials

(75) Inventors: Michelle Arney, San Francisco, CA (US); Richard Cherry, Sausalito, CA (US); Francis Jack Anderson, Fork Union, VA (US)

Correspondence Address: Michelle Arney, 795 Sutter Street #302, San Francisco, CA, 94109, US

(73) Assignee: 1747, Inc., San Francisco, CA

(21) Appl. No.: 10/323,055

(22) Filed: Dec. 18, 2002

Related U.S. Application Data
(60) Provisional application No. 60/343,011, filed on Dec. 19, 2001.

(51) Int. Cl. G06F 17/60

(52) U.S. Cl. 705/2; 705/3

(57) ABSTRACT

A method for running a clinical trial the Internet using a timeline is provided. The timeline includes one or more modules where the one or more modules define requirements for completing the clinical trial. The method comprises: (a) providing the timeline of the clinical trial to a user; (b) displaying a module in the one or more modules, the module including one or more requirements for completion; (c) receiving information from the user required by the module for completion; and (d) performing steps (b) and (c) until the one or more modules have been completed.

### CROSS-REFERENCE TO RELATED APPLICATIONS

This application claims the benefit of PPA Ser. No. 60/343,011, filed Dec. 19, 2001 by the present inventors.

### COPYRIGHT NOTICE

A portion of the disclosure recited in the specification contains material which is subject to copyright protection. Specifically, 46 pages of source code are included. The copyright owner has no objection to the facsimile reproduction of the specification as filed in the Patent and Trademark Office. Otherwise all copyright rights are reserved.

### BACKGROUND OF THE INVENTION

The present invention relates generally to a system and method for designing and running clinical trials over a communications network, and more specifically, to a system and method for designing a clinical trial for remote participants over a communications network and running the clinical trial for the remote participants over the communication network.

Clinical trials are designed around the assumption that the trial will be conducted by face-to-face contact with participants in clinics, physician offices, or hospital settings. This process requires a great time commitment from participants and the trial personnel. Generally, clinical trials include many steps and most steps are currently conducted with some sort of human interaction. Because of burdensome nature of face-to-face contact for a majority of the steps, clinical trials often take an enormous amount of time to complete.

In addition to the time commitment required for running a clinical trial, the design of the clinical trial is also complicated and time consuming. In some cases, the design of a complete clinical trial may take longer than administering the trial. Also, because of the extensive Food and Drug and Administration (FDA) guidelines for clinical trials, every step of the trial must be detailed and documented before the FDA will consider giving approval. Thus, the design of a complete trial that will be approved by the FDA will require an enormous amount of time.

Completed randomized clinical trials are needed to determine the efficacy of the drug and also to obtain final approval from the FDA to distribute and market the drug. If a drug is proven to be effective in trials and finally approved by the FDA, a company will desire to distribute and sell the drug as early as possible. This maximizes the revenue received from the drug and also guards against competitors who may be developing similar drugs from releasing those drugs before the company's drug. Also, the time in the market while the drug is still under patent protection is extended. For some drugs, every day a drug is delayed in being released into the market costs a Pharmaceutical company approximately one million dollars. Accordingly, with the extended time the clinical trials require, a company may lose valuable revenue or have a competitor release a similar drug before them.

### SUMMARY OF THE INVENTION

A method for running a clinical trial via the Internet using a timeline is provided. The timeline includes one or more modules, wherein the one or more modules define requirements for completing the clinical trial. The method comprises: (a) providing the timeline of the clinical trial to a user through the network; (b) displaying a module in the one or more modules of the timeline, the module including one or more requirements for completion; (c) receiving information from the user required by the module for completion through the network; and (d) performing steps (b) and (c) until the one or more modules have been completed.

### DETAILED DESCRIPTION OF THE INVENTION

Details of the present invention are provided in the thirteen documents accompanying this application as follows:

1. Development Path document (1 page).

2. Module diagram document (24 pages).

3. Data Collection Module Draft, DataCollectionModule.doc, Version 1.0 (14 pages).

4. Data Collection Logic Diagram (2 pages).

5. Diagram of Timing Concepts for Data Collection Module (1 page).

6. Study Designer Flow Diagrams and Web shots (23 pages).

7. Participant Flow Diagrams and Web shots (19 pages).

8. Flow diagrams (46 pages).

9. Series timing and Windows (1 page).

10. Top level view of screen shots (2 pages).

11. patent application Ser. No. 09/544,909, Method and system for performing clinical trials over the Internet, filed on Apr. 7, 2000 (17 pages, 6 drawing pages).

12. Description of screen shots (2 pages).

13. Screen shots (48 pages).

14. Source Code (46 Pages)

In one embodiment of the present invention, a system and method for automating the design and running of clinical trials is provided. A system is provided to a user that automates the running of a clinical trial through a communication medium. The communication medium may be a network, such as local area networks, wide are networks, campus networks, and the Internet. A user may access the clinical trial through the Internet using a peripheral, such as a personal computer, Personal Digital Assistant (PDA), pocket PC, cellular telephone, etc.

The clinical trial includes a timeline that a user follows in completing the clinical trial. The timeline includes steps or modules that are necessary for running the clinical trial through the Internet. The modules have been identified and configured by a designer of the specific clinical trial. For example, a timeline may include one or more of the following modules: Register, verify ID, screening, trial consent, baseline data, drugs shipped, drugs received, study data, return leftovers, and study results.

The register module allows a user to register with the clinical trial. The verify ID module verifies and authenticates the identification information of the user. The screening module screens users and determines if a user is appropriate for the clinical trial. The trial consent module obtains a users consent to participate in the clinical trial. The baseline data module obtains baseline data from a user. A randomization/assignment module determines whether the user will receive real drugs or placebo drugs. The drugs shipped module determines the drugs that should be shipped to a user and facilitates the shipping of the drugs. The drugs received module verifies that the drugs have been received. The study data obtains data from a user during the use of the drug. The return leftovers module retrieves the amount of drugs leftover and facilitates the returning of the drugs for drug reconciliation purposes. And, the study results provides analysis of the data collected.

The modules in the timeline allow a user to complete an entire clinical trial through the Internet. The user reports all data that is required by each module and once each module has been completed by the user, a clinical trial has been performed through the Internet.

In one embodiment, a system and method for the design of a clinical trial is provided. The system provides a guide that facilitates the designing of a clinical trial that is performed through the Internet. A designer tool is provided for configuring each module described above. Additionally, designer tools are provided for configuring other modules that are used by providers running the clinical trial and not the participants themselves. An example of modules used in designing the clinical trial includes design study, build site, recruit, registration, ID verification, informed consent, randomization/assignment, drug delivery/return, data collection, analysis, FDA submission, reporting, safety monitoring, pilot, surveys, administration, exit study, participant relations, and concomitant meds.

In designing the clinical trial, a designer determines a timeline by identifying steps that a user will follow on-line. Additionally, a designer determines modules that are needed for a provider to facilitate administering the on-line clinical trial.

In one embodiment, instruments are provided for developing a module in the timeline for a user. The instruments include one or more questions and potential answers for the questions that are specifically designed for the module. The questions for the module may be specifically designed for use with the module, the questions may be generic for one or more modules, and/or the questions may be created using the instructions. Instructions also include features, such as dependencies, order, and timing, that are usable for questions and/or instruments. Once the questions and instruments are chosen and configured for the module, a module has been designed for use. A module will likely go through an approval process before the trial is launched. The approvers may be internal to a Pharmaceutical company, or external entities, such as the FDA, or an Institutional Review Board (IRB).

In one embodiment, a system and method for collecting data in a clinical trial performed through a Web site is provided. The data collection module is designed using one or more instruments provided for the module. The instruments include one or more questions that are configured for data collection. The questions are designed to collect data from a user participating in the clinical trial. The question types may be, for example, true or false, number, select-one, select-multiple, data, time, short text, paragraph, and rating matrix questions. Once the questions are determined and configured, an instrument for the data collection module is configured. Instruments may also include order, dependency, and timing features that allow the accurate displaying and gathering of data through the web site

The above description is illustrative but not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

What is claimed is:

1. A method for running a clinical trial via a network using a timeline the timeline including one or more modules, wherein the one or more modules define requirements for completing the clinical trial, the method comprising:
(a) providing the timeline of the clinical trial to a user through the network;
(b) displaying a module in the one or more modules, the module including one or more requirements for completion;
(c) receiving information from the user required by the module for completion through the network; and
(d) performing steps (b) and (c) until the one or more modules have been completed.

2. The method of claim 1, where in network comprises at least one of local area networks, wide are networks, campus networks and the Internet.

3. A method for designing clinical trials, wherein the clinical trials are completed via a network, the method comprising:
providing a set of modules usable in the clinical trials;
receiving a selection of one or more modules in the set of modules to include in a clinical trial;
receiving configuration information for the one or more modules selected for the clinical trial; and
generating a configured clinical trial using the configuration information for the one or more modules, wherein the configured clinical trial includes the configured one or more modules, wherein the configured one or more modules allow the configured clinical trial to be completed through the network.

4. The method of claim 3, where in network comprises at least one of local area networks, wide are networks, campus networks, and the Internet.

5. A system for running a clinical trial via the Internet as described by the disclosures herein.

6. A system for designing clinical trials to be completed via the Internet as described by the disclosures herein.
